(19) United States
(12) Patent Application Publication
(10) Pub. No.: US 2013/0007782 A1
(43) Pub. Date: Jan. 3, 2013

(54) Programming selection

(76) Inventors: Carl S. Marshall, Portland, OR (US); Adam T. Lake, Portland, OR (US); Bradford H. Needham, North Plains, OR (US)

(21) Appl. No.: 13/540,790

(22) Filed: Jul. 3, 2012

Related U.S. Application Data
(63) Continuation of application No. 10/177,825, filed on Jun. 21, 2002.

(51) Int. Cl. H04N 21/482; H04N 21/4185

(52) U.S. Cl. 725/5; 725/40

(57) ABSTRACT

In one configuration, electronic program guides (EPGs) are used to display past, present and future broadcasts, where selection of a past broadcast results in a search for the broadcast. If the broadcast is available, it is provided to the requester. Various embodiments are disclosed for controlling costs associated with broadcast acquisition, identifying a desired quality level for a broadcast, applying policies to regulate receipt of broadcast data, and for renting broadcasts.

### CROSS-REFERENCE TO RELATED APPLICATIONS

This application is a continuation of prior co-pending U.S. patent application Ser. No. 10/177,825 filed Jun. 21, 2002.

### FIELD OF THE INVENTION

An embodiment of the invention generally relates to audio/visual recording devices, and more particularly to a system enabling recording of past broadcasts that have been cached or otherwise saved by a device.

### BACKGROUND

The Personal Video Recorder (PVR) has changed the way people view audio/visual broadcasts, such as television shows, movies, etc Akin to a Video Cassette Recorder (VCR), the PVR allows one to record broadcasts while not being in the presence of their television or other output device, or while watching a different broadcast. In contrast with VCRs which are analog recording devices, PVRs are intended to record digital broadcasts, and are often incorporated into digital receivers, e.g., digital television set-top boxes. Well known exemplary PVR devices are the ReplayTV.™. PVR by SONICblue Inc., and the TiVo PVR by TiVo Inc.

Currently, an Electronic Program Guide (EPG) can be used in conjunction with a PVR to set a recurring schedule for recording future broadcasts of some show. Some PVRs allow for automatically deleting older recordings in order to make room for newer recordings.

### BRIEF DESCRIPTION OF THE DRAWINGS

The features and advantages of the present invention will become apparent from the following detailed description of the present invention in which:

FIG. 1 illustrates an exemplary system of devices, including a personal video recorder which may obtain data to record from other peer devices.

FIG. 2 illustrates an exemplary Electronic Programming Guide according to one embodiment.

FIG. 3 is a flowchart according to one embodiment for searching for a particular broadcast.

FIG. 4 illustrates a flowchart according to one embodiment for updating advertising within a broadcast.

FIG. 5 illustrates a flowchart according to one embodiment for charging a premium for delivering a broadcast without commercials.

FIG. 6 illustrates a suitable computing environment in which certain aspects of the invention may be implemented.

### DETAILED DESCRIPTION

As used herein, the term “broadcast” is not intended to be limited to over-air delivery of data, e.g., a terrestrial television broadcast, and instead is intended to encompass the general concept of data that has been generally distributed over any medium for receipt by one or more entities. The term is used is used both as a verb and a noun, and thus may be used herein to reference the act of broadcasting data, or to reference to the broadcasted data itself. The following description assumes use of a digital PVR to locate broadcasts stored on peer digital devices. However, it will be appreciated an analog VCR or other analog device may be used to implement the invention. For example, assuming a digital device is necessary to search for and locate audio/visual recordings, an intermediary device, such as a properly configured computer, may be used as a front end to control or otherwise provide input to an analog recorder. The intermediary device may also be utilized to provide an analog device's recording to other devices in accord with principles of the invention discussed below.

Generally, when it is desired to view a broadcast, one either watches a program when broadcast, or configures a recorder to record the broadcast as it occurs. Unfortunately, if the broadcast is missed, or the recorder not properly configured to record, then one cannot view the broadcast unless someone can be located that can provide his or her recording of the program. Illustrated embodiments of the invention address this issue of accessing such past broadcasts. Embodiments of the invention also address one's desire to see a broadcast that has occurred, or is occurring, in one time zone, but has not yet occurred in a local time zone. For example, it may be desired to view a television network program presented at 8 pm Eastern Standard Time (EST), at 5 pm Pacific Standard Time (PST). In some embodiments, a peer device may associate access terms with broadcasts to control access to the broadcasts, e.g., terms may identify a rental charge, purchase price, license arrangement, prepayment requirement, subscription agreement, token economy, or other business arrangement.

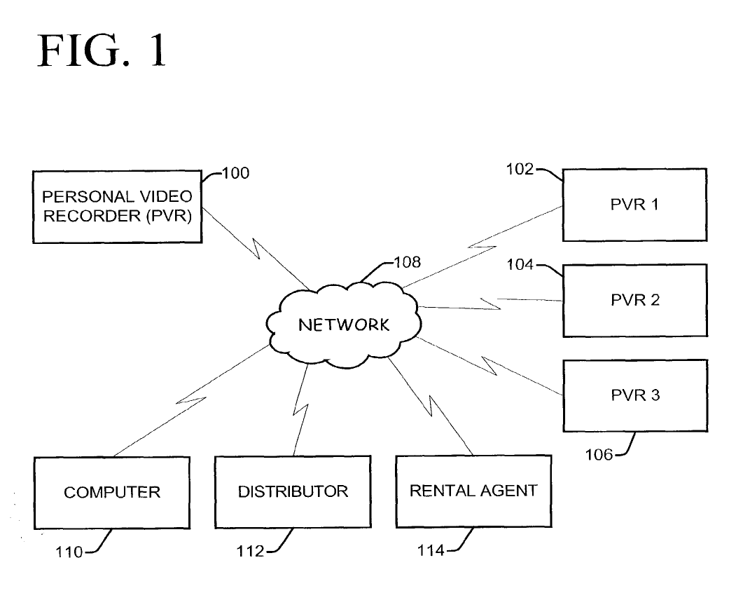

FIG. 1 illustrates an exemplary system of devices, including a personal video recorder 100 (PVR) which may obtain data to record from other peer devices, including other PVRs 102-106, such as consumer devices installed within an end user home or other establishment. In the illustrated embodiment, a network 108 couples the PVRs 100-106. In addition to other PVRs, it will be appreciated that other devices, such as a computer 110, data distributor 112, or rental agent 114, may also operate as a data source. In one embodiment, devices 100-114 using the network communicate using a secured, e.g., cryptographically, protocol to safeguard proper functioning of the system.

A broadcast may be delivered in a variety of formats, including raw data, or packaged with associated data, e.g., meta-data. For example, a broadcast may be packaged with SOAP (Simple Object Access Protocol), SGML (Standard Generalized Markup Language), XML (Extensible Markup Language), HTML (HyperText Markup Language), or other language that identifies characteristics, context, or other information about a broadcast, and may include security data to control access. PVRs 100-106 are assumed to honor such security data. In another embodiment, if PVRs or other devices are not trusted, cryptographic security measures may be employed so that a broadcast is received in an encrypted form, and one or more decoding keys are required for decoding the broadcast in accord with some access agreement or policy.

As discussed above, the computer 110 or other device may operate as an intermediary, or front end, for analog devices. Or, the computer may be used as a front end for a PVR to provide new capabilities to the PVR. For example, a PVR may not know how to respond to a certain request from a peer device Akin to being an intermediary for an analog device, the computer may support functions not known to the PVR. A PVR may be configured with a command language and command input to allow the PVR to be controlled by the computer, e.g., the computer may direct the PVR to switch to a certain input or channel, start/stop recording at a certain time, provide data to a peer device, etc.

A business model for broadcasters may be developed around use of devices containing encrypted past programs stored at very high quality, and which can be sent to and viewed by a peer PVR for a fee. This is a revenue opportunity for content creators, broadcasters, re-broadcasters, and advertisers. For example, the data distributor 112 may be the equivalent of an online retailer maintaining a large library of past broadcasts, along with associated costs or access terms for providing the broadcast at varying qualities. Thus, if PVR 100 cannot locate another peer device offering a particular broadcast for free, or if no peer device has the broadcast at a desired quality, then the PVR 100 may purchase the broadcast from the distributor. In one embodiment, since commercial advertising is often time dependent, rather than distributing a broadcast with originally provided advertising that may now be out of date, instead the distributor replaces originally aired commercials with new advertising when providing the broadcast. In a further embodiment, a requesting peer may elect to pay a higher premium to receive the broadcast without any advertising.

The rental agent 114 may be the equivalent of a video rental store. In one embodiment, the rental agent may provide a desired broadcast for a rental fee (with possibly an option to purchase). In one embodiment, security measures are employed to prevent use of a rented broadcast beyond a certain period of time. For example, a rented broadcast may be packaged with SOAP, where the package identifies security information including authorized player devices, e.g., PVR 100, authorized time periods, e.g., a 5 day rental, or the like. In embodiments where PVRs or other devices are not trusted, cryptographic security measures may be employed such that a rented broadcast is received in an encrypted form, and access to keys required for decoding is controlled in accord with a rental agreement.

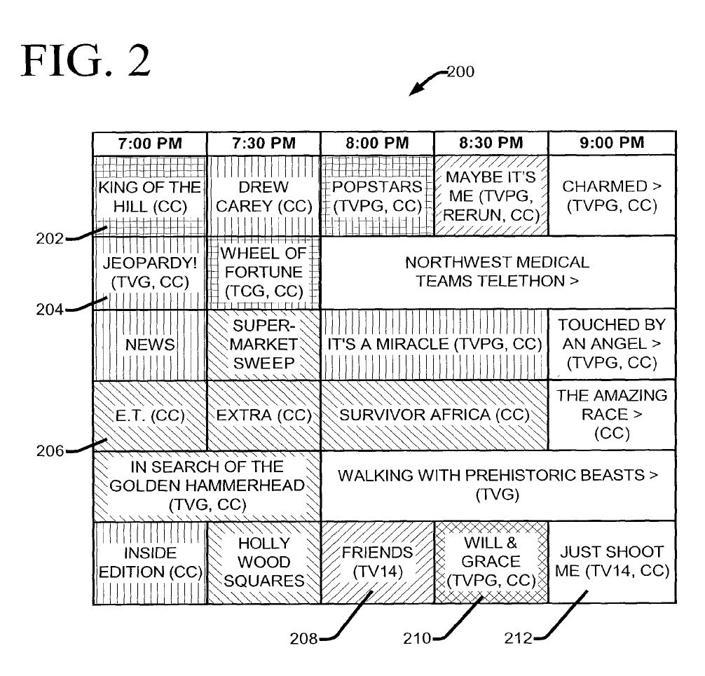

FIG. 2 illustrates an exemplary Electronic Programming Guide (EPG) 200 according to one embodiment. Conventional analog and PVR recording systems, such as those provided by TiVo or ReplayTV, allow one to select from an EPG a future broadcast to be recorded. Illustrated embodiments of the invention extend this recording capability by providing an EPG that includes a history of past programming so that a past broadcast may be selected for recording.

In the illustrated embodiment, the EPG 200 includes optional quality indicators 202-212 that allow one to select broadcasts having a certain level of quality. That is, a particular PVR user may have elected to record a broadcast in low quality, for example, to minimize depleted recording space, or for broadcasts where high quality is unnecessary, and the EPG may reflect the lower quality. As with scheduling a future recording, the EPG can be used to locate past broadcasts that are available over a peer-to-peer (P2P) or equivalent network. It will be appreciated many different network topologies and technologies may underlie a P2P network; the invention is operable over any network or carrier allowing searching for and retrieval of past broadcasts.

In addition to listing past, present and future broadcasts, an EPG may be annotated to indicate availability and characteristics of broadcasts. For example, the grid pattern 202 may represent available past broadcasts that are only available from PVRs or other devices having a slow connection to the FIG. 1 network 108. The vertical line pattern 204 may represent past broadcasts that are currently unavailable. The slanted-right line pattern 206 may represent available past broadcasts that are available from PVRs or other devices having a fast connection to the FIG. 1. The slanted-left line pattern 208 may represent available past broadcasts that have been recorded in a particular quality, e.g., to identify a low-quality recording. The diamond line pattern 210 may represent available past broadcasts that are available in arbitrary quality. For example, such an indicator may be used to identify broadcasts available from the FIG. 1 distributor 112, where the distributor can arbitrarily provide a broadcast in any desired quality (a lower quality may correspond to a lower price). The no-line EPG entries 212 may correspond to current or future broadcasts for which no past recording yet exists.

It will be appreciated that the illustrated EPG is exemplary only, and that many more characteristics of broadcasts would likely be represented in a complete EPG. Further, while various line patterns are illustrated to highlight different EPG entries, it will be appreciated that embodiments may utilized colors, icons, sounds, or other cues to identify various recording qualities, access rights (e.g., free or for fee) or other characteristics for a past broadcast. Cues may include special sounds, selection assistance, magnification, or other action to facilitate use by persons with disabilities. Cues may also indicate whether a program is copyrighted, available for a particular fee, able to be redistributed, etc. The EPG annotations may be updated in various ways, including use of push or pull technology, incident to a search for a particular broadcast, or according to some other update technology.

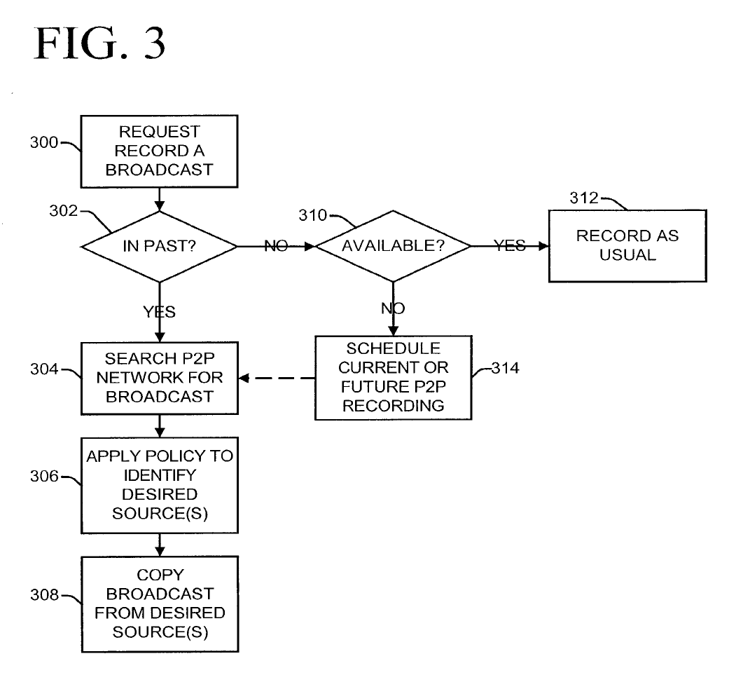

FIG. 3 is a flowchart according to one embodiment for searching for a particular broadcast. A request to record a show is received 300. In one embodiment, the request is generated by clicking on (or otherwise selecting) an EPG entry. However, other embodiments of the invention may use other selection techniques, including selection activity by a user, or selections generated by an application program, such as an expert system or the like. The request may include desired broadcast characteristics, such as desired recording quality, download speed, or the like.

A test 302 is performed to determine whether the selection corresponds to a past broadcast. If so, a search is performed 304 to locate the desired broadcast within the P2P network. Various techniques or combination of techniques may be used to implement the search. For example, a database, either central or distributed, may be used to track broadcasts currently available by all devices known to the database. For example, each PVR or other device may operated to update the database each time a recording is made. Or, a P2P discovery protocol can be employed to locate PVRs or other devices currently communicatively coupled to a searching 304 device, and these PVRs can be queried to determine whether they contain the desired broadcast.

Assuming the desired broadcast is located, a local policy may be applied 306 to search results. Assuming an EPG mode of generating the request 300 to record a broadcast, there may be characteristics (e.g., associated meta data) of the broadcast that are known but not necessarily reflected in the EPG listing. For example, one may want to download broadcasts written by a particular person. Or, policies may be used to implement parental controls or other content restrictions, usage time restrictions, or the like. Or, one might define a policy to alter the request under certain circumstance. For example, if recording space becomes insufficient for a requested recording, the request may be dynamically altered to request the broadcast at a lower quality to fit available space. Policies may also be used to check whether the accessing device has sufficient rights to the broadcast. For example, copyrighted programs may have associated access requirements that a policy engine may validate. In one embodiment, associated metadata includes data for defining or tracking social networks that group devices or users thereof according to various characteristics. For example, a group may be defined for users interested in broadcasts written by a particular person. It will be appreciated by one skilled in the art that many different criteria, including kinship, interpersonal relationships, common interests, etc. may be employed for defining and maintaining social groups.

Once the desired broadcast has been located, and policies (if any) applied, the broadcast is copied 308 to the requesting device. Note that the broadcast may be copied from one or more sources simultaneously. For example, there may be two sources of a broadcast. To speed up data transfer, different portions of the broadcast may be obtained in parallel. This is advantageous if a source having a high-speed connection is charging an access fee, but several sources having low-speed connections are not charging. Several low-speed sources may be accessed in parallel to achieve or exceed the throughput offered by the fee based source.

If the test 302 indicates the requested broadcast is not in the past, a test 310 may be performed to determine whether the broadcast is available for by other means, e.g., through conventional selection of future recordings. If so, then the recording is made 312 as usual. However, if for some reason, a future broadcast is not yet available, then a future P2P recording can be scheduled 314 to take place when the broadcast has passed. For example, there may be area blackouts that prevent local access to a broadcast. In one embodiment, it is not necessary for recording of a broadcast to complete before it can be accessed by peer devices, and one device may repeat a broadcast for another device. For a broadcast only occurring at a particular time in different time zones, this allows, for example, a device in an earlier time zone to access to a broadcast occurring in a later time zone.

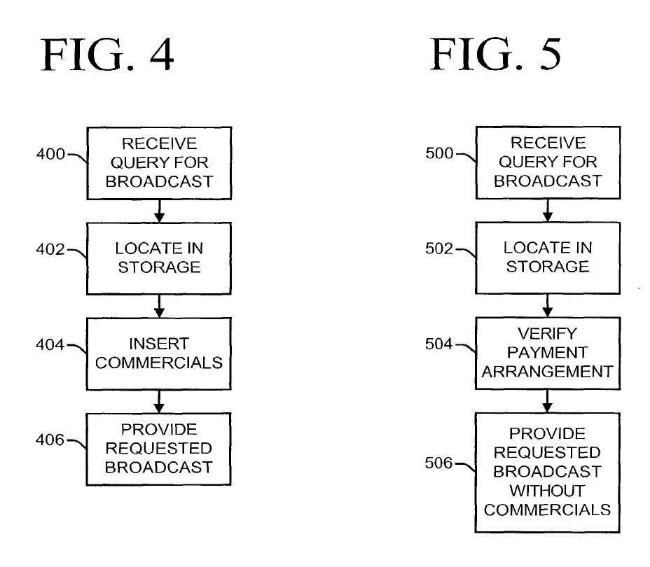

FIG. 4 illustrates a flowchart according to one embodiment for updating advertising within a broadcast. Commercials are often time and locale sensitive, and it may be advantageous to update commercials when redelivering a broadcast so as to suit the time or locale a particular receiving device. After receiving, such as by the FIG. 1 distributor 112, a request 400 for a broadcast the broadcast is located 402 in storage. Assuming the device receiving the request has a version of the requested broadcast that contains indicia of where commercials are placed, commercials are inserted 404 into the broadcast, and the requested broadcast is then provided 406 to the requester. It will be appreciated that the commercials may be inserted on-the-fly as the broadcast is sent to the requester, or the broadcast may be packaged with commercials and then delivered to the requester. If the stored broadcast does not have indicia of commercial placement, it will be appreciated that various known manual or automatic discovery techniques may be utilized to determine commercial placement in the provided 406 broadcast.

FIG. 5 illustrates a flowchart according to one embodiment for charging a premium for delivering a broadcast without commercials. Generally, commercials pay many or all costs associated with producing a particular broadcast. But, some people do not want commercial advertising interrupting their broadcast. And, commercials may consume valuable storage space in a PVR or other recording device. Thus, a requester may be willing to pay a fee for the right to receive a commercial free broadcast. This fee can be used to offset costs associated with broadcast production.

After receiving a request 500 for a broadcast, the broadcast is located 502 in storage. After validating 504 payment arrangements have been secured with a requester, the requested broadcast is then provided 506 to the requester. Assuming stored broadcasts include originally provided commercials (broadcasts may be stored without any commercials, but with indicia of where commercials are to be placed), the device receiving the request removes the commercials and provides 506 to broadcast to the requester. It will be appreciated that the commercials may be deleted on-the-fly as the broadcast is sent to the requester, or the broadcast may be packaged without commercials and then delivered to the requester. If the stored broadcast does not have indicia of commercial placement, various known manual or automatic discovery techniques may be utilized to determine the location of commercials that are to be removed from the provided 506 broadcast.

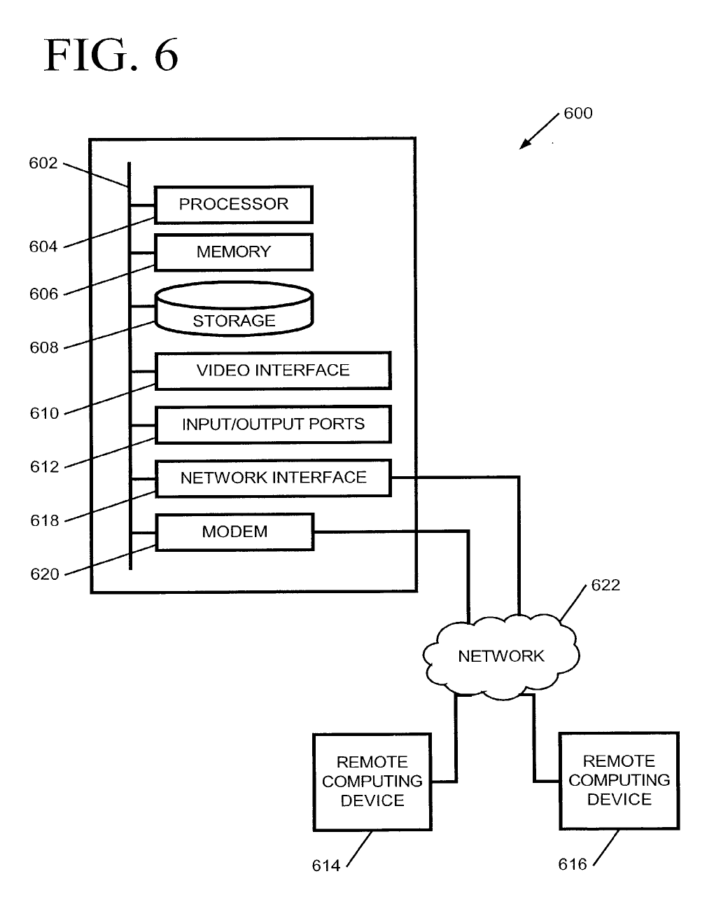

FIG. 6 and the following discussion are intended to provide a brief, general description of a suitable computing environment in which certain aspects of the illustrated invention may be implemented. For example, the illustrated environment includes a machine 600 which may embody the PVR 100 or Computer 100 of FIG. 1. As used herein, the term “machine” includes a single machine, such as a computer, handheld device, etc., or a system of communicatively coupled machines or devices.

Typically, the machine 600 includes a system bus 602 to which is attached processors 604, a memory 606 (e.g., random access memory (RAM), read-only memory (ROM), or other state preserving medium), storage devices 608, a video interface 610, and input/output interface ports 612. The machine may be controlled, at least in part, by input from conventional input devices, such as keyboards, mice, joysticks, as well as directives received from another machine, interaction with a virtual reality (VR) environment, biometric feedback, or other input source or signal.

The machine may also include embedded controllers, such as Generic or Programmable Logic Devices or Arrays, Application Specific Integrated Circuits, single-chip computers, smart cards, or the like, and the machine is expected to operate in a networked environment using physical and/or logical connections to one or more remote machines 614, 616 through a network interface 618, modem 620, or other data pathway. Machines may be interconnected by way of a wired or wireless network 622, such as the network 108 of FIG. 1, an intranet, the Internet, local area networks, and wide area networks. It will be appreciated that network 622 may utilize various short range or long range wired or wireless carriers, including cellular, cable, laser, satellite, microwave, Bluetooth, optical, and infrared.

The invention may be described by reference to or in conjunction with program modules, including functions, procedures, data structures, application programs, etc. for performing tasks, or defining abstract data types or low-level hardware contexts. Program modules may be stored in memory 606 and/or storage devices 608 and associated storage media, e.g., hard-drives, floppy-disks, optical storage, magnetic cassettes, tapes, flash memory cards, memory sticks, digital video disks, biological storage. Program modules may be delivered over transmission environments, including network 622, in the form of packets, serial data, parallel data, propagated signals, etc. Program modules may be used in a compressed or encrypted format, and may be used in a distributed environment and stored in local and/or remote memory, for access by single and multi-processor machines, portable computers, handheld devices, e.g., Personal Digital Assistants (PDAs), cellular telephones, etc.

Thus, for example, with respect to the illustrated embodiments, assuming machine 600 embodies the PVR 100 of FIG. 1, then remote machines 614, 616 may respectively be the peer PVR 102 and distributor 112 of FIG. 1. It will be appreciated that remote machines 614, 616 may be configured like machine 600, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

1-46. (canceled)

47. A method comprising:
displaying a guide that permits selection of one or more programming selections, the guide including broadcasts available from a data distributor and a rental agent; and
receiving the one or more programming selections at a plurality of devices so as to permit viewing of the one or more programming selections at the plurality of devices, the plurality of devices including a handheld device.

48. The method of claim 47, wherein:
the rental agent is a video rental agent that provides a desired broadcast for a rental fee; and
the data distributor maintains a past broadcast library along with associated costs of access to the library broadcasts.

49. The method of claim 47, wherein:
the guide displays results of a search to locate a desired broadcast.

50. A method comprising:
displaying a guide that permits selection of one or more programming selections, the guide including past and present broadcasts available from a data distributor and a rental agent; and
receiving the one or more programming selections at a plurality of devices so as to permit viewing of the one or more programming selections at the plurality of devices, the plurality of devices including a handheld device.

51. The method of claim 50, wherein:
the guide also includes future broadcasts; and
the guide identifies past broadcast recording qualities.

52. The method of claim 50, wherein:
the past broadcasts include free and for-fee past broadcasts.

53. A method comprising:
responsive to selecting one or more programming selections via a guide, providing the one or more programming selections so as to permit viewing of the one or more programming selections at a plurality of devices, the guide including broadcasts available from a data distributor and a rental agent, the plurality of devices including a handheld device.

54. The method of claim 53, wherein:
the rental agent is a video rental agent that provides a desired broadcast for a rental fee; and
the data distributor maintains a past broadcast library along with associated costs of access to the library broadcasts.

55. The method of claim 53, wherein:
the guide displays results of a search to locate a desired broadcast.

56. A method comprising:
responsive to selecting one or more programming selections via a guide, providing the programming selection so as to permit viewing of the one or more programming selections at the plurality of devices, the guide including past and present broadcasts available from a data distributor and a rental agent, the plurality of devices including a handheld device.

57. The method of claim 56, wherein:
the guide also includes future broadcasts; and
the guide identifies past broadcast recording qualities.

58. The method of claim 56, wherein:
the past broadcasts include free and for-fee past broadcasts.

59. An apparatus comprising:
a machine to display a guide to permit selection of one or more programming selections, the guide including broadcasts available from a data distributor and a rental agent, the one or more programming selections to be received at a plurality of devices so as to permit viewing of the one or more programming selections at the plurality of devices, the plurality of devices including a handheld device.

60. The apparatus of claim 59, wherein:
the rental agent is a video rental agent to provide a desired broadcast for a rental fee; and
the data distributor is to maintain a past broadcast library along with associated costs of access to the library broadcasts.

61. The apparatus of claim 59, wherein:
the guide is to display results of a search to locate a desired broadcast.

62. An apparatus comprising:
a machine to display a guide to permit selection of one or more programming selections, the guide including past and present broadcasts available from a data distributor and a rental agent, the one or more programming selections to be received at a plurality of devices so as to permit viewing of the one or more programming selections at the plurality of devices, the plurality of devices including a handheld device.

63. The apparatus of claim 62, wherein:
the guide also includes future broadcasts; and
the guide identifies past broadcast recording qualities.

64. The apparatus of claim 62, wherein:
the past broadcasts include free and for-fee past broadcasts.

65. An apparatus comprising:
a machine to provide, responsive to selecting one or more programming selections via a guide, the one or more programming selections so as to permit viewing of the one or more programming selections at a plurality of devices, the guide including broadcasts available from a data distributor and a rental agent, the plurality of devices including a handheld device.

66. The apparatus of claim 65, wherein:
the rental agent is a video rental agent to provide a desired broadcast for a rental fee; and
the data distributor is to maintain a past broadcast library along with associated costs of access to the library broadcasts.

67. The apparatus of claim 65, wherein:
the guide is to display results of a search to locate a desired broadcast.

68. An apparatus comprising:
a machine to provide, responsive to selecting one or more programming selections via a guide, the programming selection so as to permit viewing of the one or more programming selections at the plurality of devices, the guide including past and present broadcasts available from a data distributor and a rental agent, the plurality of devices including a handheld device.

69. The apparatus of claim 68, wherein:
the guide includes future broadcasts; and
the guide identifies past broadcast recording qualities.

70. The apparatus of claim 68, wherein:
the past broadcasts include free and for-fee past broadcasts.

71. Machine-accessible memory that includes data that when accessed by a machine results in the machine performing operations comprising:
displaying a guide that permits selection of one or more programming selections, the guide including broadcasts available from a data distributor and a rental agent; and
receiving the one or more programming selections at a plurality of devices so as to permit viewing of the one or more programming selections at the plurality of devices, the plurality of devices including a handheld device.

72. The memory of claim 71, wherein:
the rental agent is a video rental agent that provides a desired broadcast for a rental fee; and
the data distributor maintains a past broadcast library along with associated costs of access to the library broadcasts.

73. The memory of claim 71, wherein:
the guide displays results of a search to locate a desired broadcast.

74. Machine-accessible memory that includes data that when accessed by a machine results in the machine performing operations comprising:
displaying a guide that permits selection of one or more programming selections, the guide including past and present broadcasts available from a data distributor and a rental agent; and
receiving the one or more programming selections at a plurality of devices so as to permit viewing of the one or more programming selections at the plurality of devices, the plurality of devices including a handheld device.

75. The memory of claim 74, wherein:
the guide also includes future broadcasts; and
the guide identifies past broadcast recording qualities.

76. The memory of claim 74, wherein:
the past broadcasts include free and for-fee past broadcasts.

77. Machine-accessible memory that includes data that when accessed by a machine results in the machine performing operations comprising:
responsive to selecting one or more programming selections via a guide, providing the one or more programming selections so as to permit viewing of the one or more programming selections at a plurality of devices, the guide including broadcasts available from a data distributor and a rental agent, the plurality of devices including a handheld device.

78. The memory of claim 77, wherein:
the rental agent is a video rental agent that provides a desired broadcast for a rental fee; and
the data distributor maintains a past broadcast library along with associated costs of access to the library broadcasts.

79. The memory of claim 77, wherein:
the guide displays results of a search to locate a desired broadcast.

80. Machine-accessible memory that includes data that when accessed by a machine results in the machine performing operations comprising:
responsive to selecting one or more programming selections via a guide, providing the programming selection so as to permit viewing of the one or more programming selections at the plurality of devices, the guide including past and present broadcasts available from a data distributor and a rental agent, the plurality of devices including a handheld device.

81. The memory of claim 80, wherein:
the guide also includes future broadcasts; and
the guide identifies past broadcast recording qualities.

82. The memory of claim 80, wherein:
the past broadcasts include free and for-fee past broadcasts.
